(19) United States
(12) Patent Application Publication
(10) Pub. No.: US 2009/0247235 A1
(43) Pub. Date: Oct. 1, 2009

(54) INFORMATION PROCESSING APPARATUS

(75) Inventor: Michiaki OKANO, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/397,499

(22) Filed: Mar. 4, 2009

(30) Foreign Application Priority Data
Mar. 28, 2008 (JP) P2008-087991

(51) Int. Cl. H04B 1/38; H04M 1/00

(52) U.S. Cl. 455/566; 455/575.3

(57) ABSTRACT

According to the present invention, an information processing apparatus includes: an input unit; a display unit; an image output unit; an image storage unit that stores images; an image selection unit that controls the display unit to display a list of information for identifying the images stored in the image storage unit, selects one item from the list by a first operation input to the input unit, and decides the selected item as a decided item by a second operation input to the input unit; and an image display control unit that controls the image output unit to output an image identified by the decided item to exterior of the information processing apparatus.

### CROSS-REFERENCE TO RELATED APPLICATIONS

This application is based upon and claims the benefit of priority from Japanese Patent Application No 2008087991, filed Mar. 28, 2008, the entire contents of which are incorporated herein by reference.

### BACKGROUND

1. Field

The present invention relates to an information processing apparatus and a processing for displaying images to a person other than the user in a given sequence determined by the user.

2. Description of the Related Art

In general, an information processing apparatus displays images on a display unit, on which a user views images, and externally displays images by an image output unit such that a person other than the user can view the images, regardless of whether or not the user can view the images, or the number of persons. An example of external display by the image output unit is projection by a projector. The projector projects images on a screen or a wall other than the information processing apparatus. For the projector, any light source may be used.

Another example of external display by the image output unit is display by a large display unit, for example, a liquid crystal display or a cathode-ray tube. The image output unit may be incorporated into a housing of the information processing apparatus or may be detachably mounted in the information processing apparatus. The image output unit may be connected to the information processing apparatus in a wired or wireless manner. In transferring the images to the image output unit in a wired or wireless manner, any protocol may be used.

Outside display is used when the user (presenter) makes a presentation. The images include all the contents to be externally displayed, regardless of the contents. For example, still images or motion images may be used. The images may also be images including only character strings.

In the presentation, images to be displayed and a sequence of the images to display are determined by the presenter such that a person can appropriately watch the presentation and the presentation is given within a predetermined time. However, the presenter has to bear a large burden to create images to be used in a presentation every time. To solve this problem, a technology is known in which a presenter stores a plurality of images beforehand in an apparatus, images are selected from among the images, and the selected images are externally displayed.

In addition, to make it easy for the presenter to select the images, information for identifying the images, for example, thumbnail images obtained by reducing the images, are prepared beforehand in association with the images, and a list of thumbnail images of the images are displayed on the display unit. Then, if a cursor is moved to one of the displayed thumbnail images by a predetermined operation, an image corresponding to the thumbnail image indicated by the cursor is externally displayed (for example, pages 2-3 and 9-10, and FIGS. 3 and 4 in JP-A-2007-47758).

According to the method disclosed in JP-A-2007-47758, the thumbnail images are displayed on the display unit in a predetermined sequence, for example, according to the storage date and time, and accordingly it is impossible to externally display the images without depending on the sequence. In particular, when some images include confidential information, which should not be visible to the audience, the problem becomes conspicuous.

### SUMMARY OF THE INVENTION

According to an aspect of the present invention, there is provided an information processing apparatus including: an input unit; a display unit; an image output unit; an image storage unit that stores images; an image selection unit that controls the display unit to display a list of information for identifying the images stored in the image storage unit, selects one item from the list by a first operation input to the input unit, and decides the selected item as a decided item by a second operation input to the input unit; and an image display control unit that controls the image output unit to output an image identified by the decided item to exterior of the information processing apparatus.

According to another aspect of the present invention, there is provided an information processing apparatus including: an input unit; a display unit; an image output unit; an image storage unit that stores images; an image identification information storage unit that stores information for identifying the images stored in the image storage unit; an image selection unit that controls the display unit to display a list of the information for identifying the images, selects one item from the list by a first key operation input to the input unit, decides the selected item as a decided item by a second operation input to the input unit, and controls the image identification information storage unit to store information with respect to the selected item and display sequence of the selected item; and an image display control unit that selects one of the information stored in the image identification information storage unit based on the display sequence in the wake of a third operation input to the input unit, and controls the image output unit to display an image identified by the selected information.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary exterior views of a foldable mobile communication terminal according to an embodiment of the invention in a state where upper and lower housings are opened.

FIGS. 2A and 2B are exemplary exterior views of a foldable mobile communication terminal according to an embodiment of the invention in a state where upper and lower housings are closed.

FIG. 3 is an exemplary block diagram showing the configuration of a mobile communication terminal according to an embodiment of the invention.

FIG. 4 is an exemplary diagram showing an example of the configuration of an image according to an embodiment of the invention.

FIG. 5 is an exemplary diagram showing an example of the configuration of an image identifier according to an embodiment of the invention.

FIG. 6 is an exemplary flowchart of a first operation of a projection image selection unit according to an embodiment of the invention.

FIG. 7 is an exemplary diagram showing an example of display by a projection image selection unit according to an embodiment of the invention.

FIG. 8 is an exemplary diagram (first view) of an example of projection image identification information display by a projection image selection unit according to an embodiment of the invention.

FIG. 9 is an exemplary diagram (second view) of an example of projection image identification information display by a projection image selection unit according to an embodiment of the invention.

FIG. 10 is an exemplary flowchart of a second operation of a projection image selection unit according to an embodiment of the invention.

FIG. 11 is an exemplary flowchart of an operation of an image projection control unit according to an embodiment of the invention.

FIG. 12 is an exemplary diagram showing an example of projection image identification information display by an image projection control unit according to an embodiment of the invention.

### DETAILED DESCRIPTION

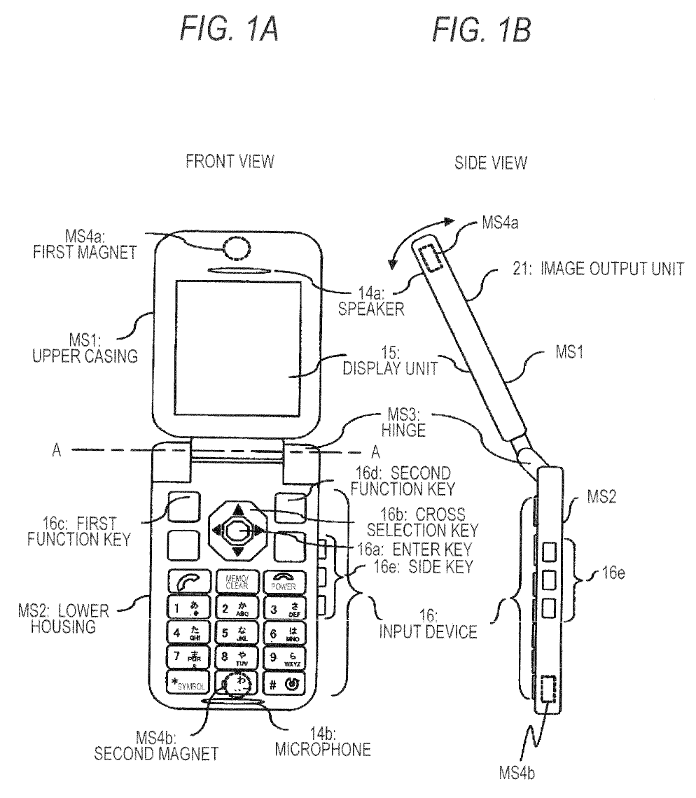

Hereinafter, an embodiment of an information processing apparatus according to the invention will be described with reference to the drawings. FIGS. 1A and 1B show the exterior structure of a foldable mobile communication terminal, which is an example of an information processing apparatus according to an embodiment of the invention, in a state where upper and lower housing are unfolded. FIG. 1A is a front view, that is, a top view, and FIG. 1B is a side view.

The mobile communication terminal has an upper housing MS1 and a lower housing MS2, which are connected to each other by a hinge MS3 to be rotatable around an axis A-A. The upper and lower housings MS1 and MS2 are opened/closed in a range of approximately 0 degree (closed state) to 180 degrees (open state). Provided on an inner surface of the upper housing MS1 are a speaker 14a that is used for an incoming speech, and a display unit 15 that is formed by an LCD (Liquid Crystal Display) with a backlight and used for display to urge a user's operation, display of the content according to the user's operation, or display of a cursor position or an operation state of the terminal. An image output unit 21 is provided on an outer surface of the upper housing MS2. The image output unit 21 is formed by a projector, which projects an image outside of the terminal.

A microphone 14b, which is used for an outgoing speech, is provided on an inner surface of the lower housing MS2. An input device 16, which is formed by a keypad, is provided on an inner surface and a side surface of the lower housing MS2. An antenna, which is used to transmit/receive an electric wave, is provided in the lower housing MS2.

The input device 16 includes, on the inner surface of the lower housing MS2, an enter key 16a that is used to instruct decision or selection of each function, four keys that are provided around the enter key 16a to surround the enter key 16a, and disposed on the up, down, left, and right sides of the enter key 16a, and a cross selection key 16b that is used to instruct movement of a cursor position on the display unit 15. A first function key 16c and a second function key 16d are provided on the inner surface of the lower housing MS2 near the display unit 15, that is, on the left and right sides near the upper housing MS1. The first function key 16c and the second function key 16d are used to select first and second functions displayed on the left and right sides at a lower part of the display unit 15, respectively.

The input device 16 further includes, on the inner surface of the lower housing MS2, numeric keys that are used to input alphanumeric characters or characters, and symbols, and a plurality of function keys that are used to input an instruction to supply or shut off power with respect to the mobile communication terminal. The input device 16 further includes a plurality of side keys 16e that are provided on the side surface of the lower housing MS2.

A first open/close detection unit (not shown) is provided in the hinge MS3 to detect whether the upper and lower housings MS1 and MS2 are opened or closed. An open/close signal is output from the first open/close detection unit.

In order to detect whether the upper and lower housings MS1 and MS2 are opened or closed, a first magnet MS4a is embedded at an upper part of the upper housing MS1 (a portion away from the hinge MS3), and a second magnet MS4b is embedded at a lower part of the lower housing MS2 (a portion away from the hinge MS3). Accordingly, in the closed state, a distance between the first and second magnets MS4a and MS4b becomes short.

For this reason, a second open/close detection unit (not shown) may be provided to detect the state by a magnetic force acting between the first and second magnets MS4a and MS4b in the closed state, and an open/close signal may be output from the second open/close detection unit. It may also be possible to detect, on the basis of the open/close signal output from the first open/close detection unit and the open/close signal output from the second open/close detection unit, whether the upper and lower housings MS1 and MS2 are opened or closed.

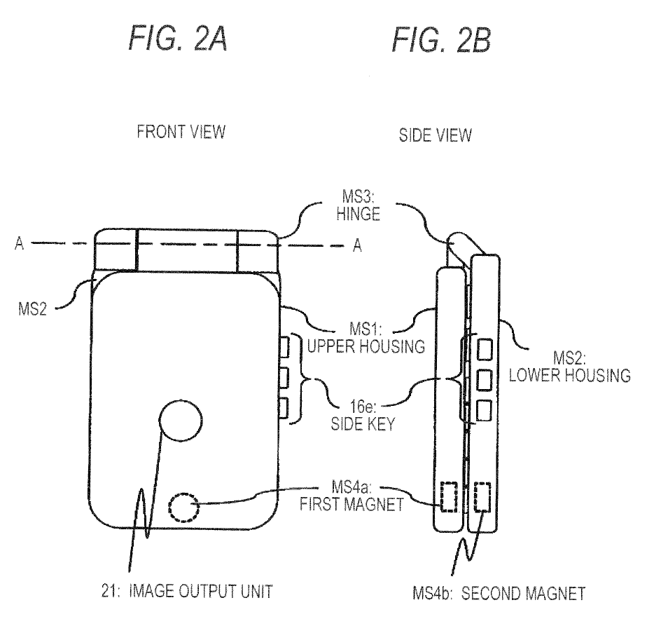

FIGS. 2A and 2B show the exterior structure when the upper housing MS1 of the mobile communication terminal is rotated around the hinge MS3, and the folder is closed such that the upper housing MS1 is near the lower housing MS2. FIG. 2A is a front view, and FIG. 2B is a side view. In a state where the folder is closed, the display unit 15 is inside the folder. Accordingly, the user cannot view display on the display unit 15. In addition, the user can operate the side keys 16e from among the keys of the input device 16, but he/she cannot operate the keys provided on the inner surface of the lower housing MS2.

Meanwhile, since projection by the image output unit 21 is performed outward, the user can view an image projected by the image output unit 21, similarly to when the upper and lower housings MS1 and MS2 are opened.

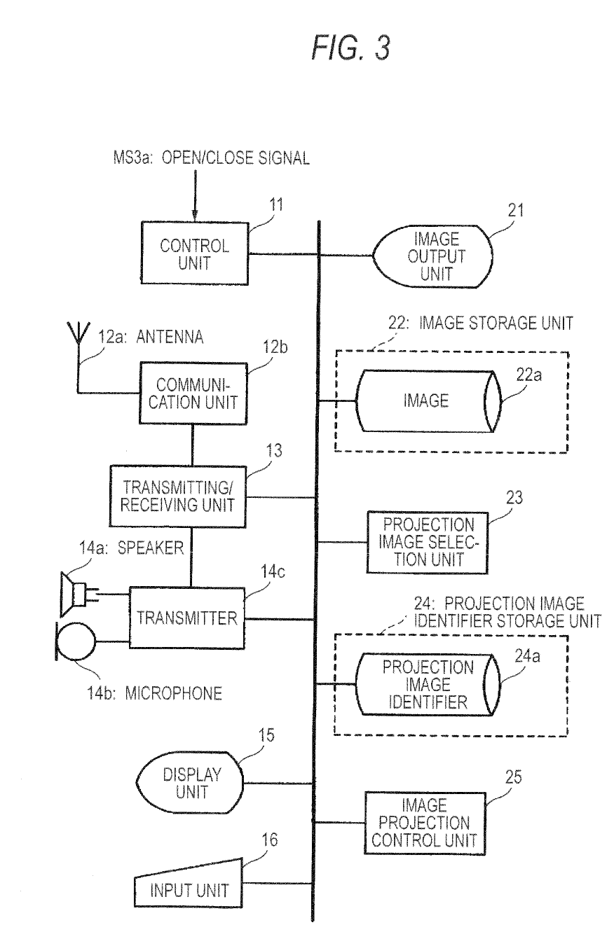

FIG. 3 is a block diagram showing the configuration of a mobile communication terminal, which is an example of an information processing apparatus according to an embodiment of the invention. The mobile communication terminal performs communication through a mobile communication network (not shown). The mobile communication terminal includes a control unit 11 that receives an open/close signal MS3a and controls the entire terminal, an antenna 12a that transmits/receives an electric wave to and from a base station (not shown), a communication unit 12b, a transmitting/receiving unit 13, a speaker 14a, a microphone 14b, a transmitter 14c, a display unit 15, and an input device 16.

The mobile communication terminal further includes an image output unit 21, an image storage unit 22, a projection image selection unit 23, a projection image identifier storage unit 24, and an image projection control unit 25. The image storage unit 22 stores images 22a. The projection image identifier storage unit 24 stores a projection image identifier 24a for identifying each image 22a to be projected by the image projection control unit 25.

The control unit 11, the projection image selection unit 23, and the image projection control unit 25 may be implemented by a program running on a computer. The control unit 11 executes the operation of an operating system (OS).

The operation of each unit of the mobile communication terminal having the above-described configuration according to an embodiment of the invention will be described with reference to FIG. 3. First, the communication unit 12b outputs a high-frequency signal received by the antenna 12a to the transmitting/receiving unit 13 and transmits, to the antenna 12a, a high-frequency signal from the transmitting/receiving unit 13.

The transmitting/receiving unit 13 amplifies, frequency converts, and demodulates the high-frequency signal from the communication unit 12b, and transmits a resultant digital sound signal and a control signal to the transmitter 14c and the control unit 11, respectively. The transmitting/receiving unit 13 also modulates, frequency converts, and amplifies the digital sound signal from the transmitter 14c and the control signal from the control unit 11 to generate a high-frequency signal, and transmits the generated high-frequency signal to the communication unit 12.

The transmitter 14c converts the digital sound signal from the transmitting/receiving unit 13 into an analog sound signal, amplifies the analog sound signal, and transmits the amplified analog sound signal to the speaker 14a. The transmitter 14c also amplifies an analog sound signal from the microphone 14b, converts the amplified analog sound signal into a digital sound signal, and transmits the digital sound signal to the transmitting/receiving unit 13.

When the user can view the display unit 15, that is, when it is determined on the basis of the open/close signal MS3a that the upper and lower housings MS1 and MS2 are opened, the display unit 15 displays characters, numerals, or image data under the control of the control unit 11. In this case, data displayed on the display unit 15 is switched by an instruction from the control unit 11 in response to a key input operation from the input device 16 or an incoming call signal.

When the user cannot view the display unit 15, that is, when it is determined on the basis of the open/close signal MS3a that the upper and lower housings MS1 and MS2 are closed, the control unit 11 controls the display unit 15 so as not to execute a display operation. When the user cannot view the display unit 15, and when the user does not operate any key of the input device 16 or no event occurs for a predetermined time, a backlight of the display unit 15 is turned off by the control unit 11. The event includes reception of an incoming call signal or end of a call.

The input device 16 includes keys, that is, numeral keys for assigning a telephone number to dial, and a plurality of function keys. If a key of the input device 16 is operated, the key input is received, and an identifier of the key is notified to the control unit 11. The identifier is received by a processing unit through the control unit 11 and the control unit 11 and displayed on the display unit 15 as characters, and a corresponding operation is executed.

The images 22a are projected on the image output unit 21 under the control of the control unit 11. The projection image selection unit 23 selects an image 22a stored in the image storage unit 22 on the basis of a predetermined key operation of the input device 16, and stores an identifier of the selected image 22a in the projection image identifier storage unit 24 as the projection image identifier 24a.

The identifier of the image 22a is stored in a sequence, and the sequence is determined by the projection image selection unit 23. The projection image selection unit 23 also stores the projection image identifier 24a in the projection image identifier storage unit 24, and deletes the projection image identifier 24a stored in the projection image identifier storage unit 24 or changes the sequence.

The image projection control unit 25 searches the image 22a, identified by the projection image identifier 24a, stored in the projection image identifier storage unit 24 from the image storage unit 22, and transmits the image 22a to the image output unit 21. The image 22a is projected on the image output unit 21.

When a plurality of projection image identifiers 24a are stored in the projection image identifier storage unit 24, the image projection control unit 25 projects an image 22a identified by one projection image identifier 24a within a predetermined time, and then projects an image 22a identified by another projection image identifier 24a. After an image 22a identified by one projection image identifier 24a is projected, an image 22a identified by another projection image identifier 24a is projected on the basis of a predetermined key operation of the input device 16.

Another projection image identifier 24a is a projection image identifier 24a immediately after or before the projection image identifier 24a of the image 22a, which is being projected. Another projection image identifier 24a may be an initial projection image identifier 24a or may be a projection image identifier 24a assigned by a predetermined key operation of the input device 16.

An operation that the image projection control unit 25 projects the image 22a selected by the projection image selection unit 23 on the image output unit 21 in the mobile communication terminal according to an embodiment of the invention will now be described.

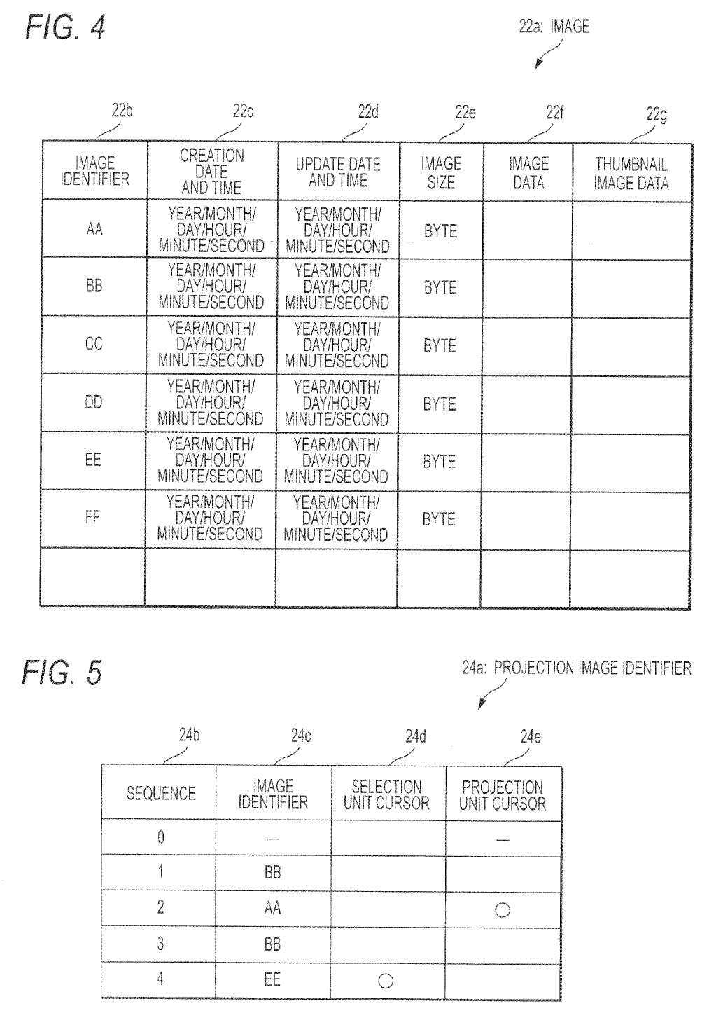

FIG. 4 shows an example of the configuration of an image 22a stored in the image storage unit 22. The image 22a includes information in association with an image identifier 22b, creation date and time 22c, update date and time 22d, an image size 22e, image data 22f, and thumbnail image data 22g. A set of associated information is information regarding one image 22a.

The image identifier 22b is information for uniquely identifying the image 22a. The creation date and time 22c, the update date and time 22d, the image size 22e, and thumbnail image data 22g are not information for uniquely identifying the image 22a, but information for information the image 22a.

The creation date and time 22c represents date and time on which the image 22a is initially stored. The update date and time 22d represents date and time on which the image 22a is latest updated and stored. The image size 22e is the number of bytes indicating a storage capacity required for storing image data 22f.

Image data 22f is information representing an image 22a. Image data 22f may be a still image or a motion image. Image data 22f may be image data with sound. Image data 22f may be compressed or uncompressed. In addition, image data 22f may be image data, such as information representing a vector figure, required for creating the image 22a.

Thumbnail image data 22g is still image data, which is similar to image data 22f and stored with a storage capacity smaller than the storage capacity required to storing image data 22f. If image data 22f is a still image, thumbnail image data 22g is formed by reducing the number of pixels of image data 22f to convert image data 22f into a small image. If image data 22f is a motion image, thumbnail image data 22g is obtained by reducing the number of pixels of a still image extracted from image data 22f to convert the extracted still image into a small image.

Thumbnail image data 22g may not be stored in the image 22a. In this case, the reference of thumbnail image data 22g means in the following description that thumbnail image data is created from image data 22f.

The images 22a may be managed by a file system (not shown). In this case, image data is managed in the form of a file, and a pointer indicating the file is stored in image data 22f. The image identifier 22b is a file name, and the image identifier 22b, the creation date and time 22c, the update date and time 22d, the image data 22e, and thumbnail image data 22g are stored in a folder. Thumbnail image data may be managed in the form of a file, and a pointer indicating the file may be stored in thumbnail image data 22g.

Although single image data may be managed as a file, all image data may be managed as a file, and single image data may be managed as a page of the file, that is, as a projection unit. In this case, an image identifier 22b is information for identifying a page.

FIG. 5 shows an example of the configuration of the projection image identifier 24a stored in the projection image identifier storage unit 24 The projection image identifier 24a includes associated information about a sequence 24b, an image identifier 24c, a selection unit cursor 24d, and a projection unit cursor 24e. A set of associated information is information about an image 22a to be projected. In other words, the projection image identifier 24a includes associated information by the amount corresponding to the number of images 22a, which can be projected. Therefore, the number of images 22a, which can be projected, is obtained in reference to the projection image identifier 24a.

The sequence 24b is information representing sequencing of the images 22a, which can be projected, and natural numbers of 1 or more are given to the images 22a without missing and being repeated. Although the sequence 24b is used to describe the sequencing of the images 22a to be projected, it may not be included in the projection image identifier 24a.

When the sequence 24b is not included in the projection image identifier 24a, information about the image 22a to be projected may be stored in a sequence, and the image 22a to be projected may be sequenced in accordance with what number each image 22a is stored. In addition, the number of images 22a to be projected may be obtained, and it may be determined whether or not an image 22a is finally sequenced.

The image identifier 24c is the image identifier 22b of the image 22a. Here, the image 22a is identified by the image identifier 24c by searching the image 22a identified by the image identifier 22b, which is the same as the image identifier 24c. For convenience of explanation, the image 22a to be identified is called the image 22a by the image identifier 24c, and a search operation by the image identifier 22b will be omitted.

The selection unit cursor 24d is an identifier that, when the projection image identifier 24a is operated by the projection image selection unit 23, is stored and referred to by the projection image selection unit 23 so as to identify the projection image identifier 24a to be operated A value (in FIG. 5, indicated by “◯”) is stored in the selection unit cursor 24d of up to one projection image identifier 24a regarding an object to be operated.

In the following description, when a value is stored in the selection unit cursor 24d of another projection image identifier 24a, an operation to store a value in the selection unit cursor 24d of a projection image identifier 24a also means an operation to erase the stored value.

The projection unit cursor 24e is an identifier that is stored and referred to by the image projection control unit 25 when image projection is controlled by the image projection control unit 25. A value (in FIG. 5, indicated by “◯”) is stored in the projection unit cursor 24e of up to one image identifier 24c regarding the image 22a to be projected.

In the following description, when a value is stored in the projection unit cursor 24e of another projection image identifier 24a, an operation to store a value in the projection unit cursor 24e of a projection image identifier 24a also means an operation to erase the stored value.

In this embodiment, the reason why a value is stored in the projection unit cursor 24e of up to one image identifier 24c is that one image 22a is projected by the image projection control unit 25 at a time. When a plurality of images 22a are projected, a value is stored in the projection unit cursor 24e of each of a plurality of image identifiers 24c.

Instead of storing the values in the selection unit cursor 24d and the projection unit cursor 24e, the sequence 24b of the projection image identifier 24a with a value stored in the selection unit cursor 24d or the projection unit cursor 24e may be stored in the projection image identifier storage unit 24. As described above, the selection unit cursor 24d and the projection unit cursor 24e are information regarding the operation of the projection image selection unit 23 and the operation of the image projection control unit 25, respectively. Therefore, the selection unit cursor 24d and the projection unit cursor 24e may be stored in a memory shared by the projection image selection unit 23 and the image projection control unit 25.

In FIG. 5, an initially sequenced virtual projection image identifier 24a is illustrated in which “0” is stored in the sequence 24b, a value is stored in the selection cursor 24d or not, and no value is stored in the image identifier 24c and the projection unit cursor 24e. In the following description, it is assumed that a set of associated information is constantly stored. A set of associated information is used to describe the operation of the projection image selection unit 23 and the operation of the image projection control unit 25.

However, the information is not limited as being stored. What is necessary is that a value can be stored in the selection unit cursor 24d of a virtual projection image identifier 24a before a real projection image identifier 24a regarding an initially sequenced image 22a to be projected (in the example of FIG. 5, a projection image identifier 24a with the sequence 24b of “1”). The information may be described as a program.

A default of a projection image identifier 24a with a value stored in the selection unit cursor 24d is a projection image identifier 24a, which is latest sequenced, that is, in which the sequence 24b of a maximum value. Meanwhile, a default of a projection image identifier 24a in which a value is stored in the projection unit cursor 24e is a real projection image identifier 24a, which is initially sequenced, that is, in which the sequence 24b is “1”.

Next, an operation that the projection image selection unit 23 selects an image 22a and stores a projection image identifier 24a in which an image identifier 22b of the selected image 22a is set as an image identifier 24c will be described. Also, an operation that the image projection control unit 25 projects the image 22a identified by the image identifier 24c of the projection image identifier 24a on the image output unit 21 will be described.

The two operations may be executed simultaneously, not exclusively. The projection image selection unit 23 stores the projection image identifier 24a in a sequence with reference to the previously stored projection image identifier 24a.

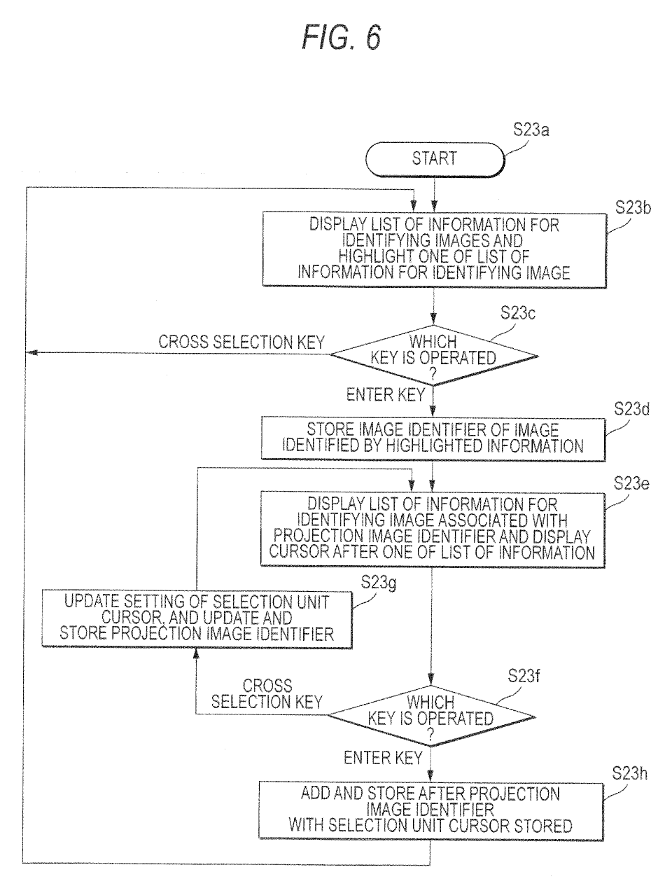

FIG. 6 is a flowchart illustrating a first operation that the projection image selection unit 23 selects an image 22a and stores a projection image identifier 24a in which an image identifier 22b of the selected image 22a is set as an image identifier 24c. The first operation is an operation when an image 22a to be projected is added, particularly, in a sequence of projection. For example, the first operation is executed when a real projection image identifier 24a is not stored, that is, when a projection image identifier 24a is newly stored.

The projection image selection unit 23 is actuated by the control unit 11 on the basis of a predetermined key operation of the input device 16, and starts the first operation (Step S23a). Next, a list of information for identifying the images 22a is displayed on the display unit 15, and one from among the images 22a is selected, and information for identifying the image 22a is highlighted (Step S23b).

The list is displayed in a first sequence according to one of the image identifiers 22b, the creation date and time 22c, the update date and time 22d, and the image size 22e, and when the first sequence is the same (the image sizes 22e may be the same), is then displayed in a second sequence according to another value. The list may be sequenced in an ascending order or a descending order. The information for identifying the image 22a highlighted immediately after the operation of the projection image selection unit 23 is information displayed at an initial position when the list is displayed, but this is not intended to limit the invention. The information may be information displayed at a last position.

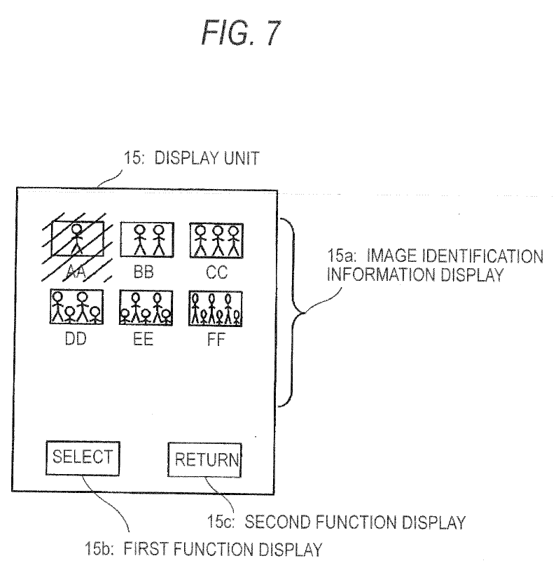

FIG. 7 shows an example where a list of information for identifying the images 22a is displayed on the display unit 15. In this example, image identification information display 15a, in which thumbnail image data 22g of images 22a and image identifiers 22b are arranged as information for identifying the images 22a shown in FIG. 4, is displayed in an upper half portion of the display unit 15. First function display 15b, “select”, is displayed in a lower left portion of the display unit 15, and second function display 15c, “return”, is displayed in a lower right portion of the display unit 15. Thumbnail image data 22g of the image 22a and the image identifier 22b are hereinafter referred to as image icons.

The image icons in the image identification information display 15a are displayed in an ascending order of the image identifier 22b. The image identifier 22b is a character string, and the ascending order of the image identifier 22b means the character strings are sorted in an alphabetical order. A single image icon is displayed over several rows of the display unit 15, and three image icons are displayed in each line. An image icon to be displayed ahead is displayed in an upper line, and in the same line, on the left side. The sequence of the display positions are based on the arrangement of characters when a sentence is described horizontally, and follows a user's actual feeling.

Hatching indicates that an image icon, which has an image identifier 22b “AA” and is displayed in the first line and on the leftmost side, is highlighted. The highlighting is not limited to the hatching. For example, a frame of thumbnail image data 22g included in the image icon may be colored with a color different from the frames of other thumbnail image data 22g. What is necessary is that a selected image icon is displayed differently from other image icons.

The operation of the projection image selection unit 23 will be further described with reference to FIG. 6. The projection image selection unit 23 examines a key operation of the input device 16 (Step S23c). When the cross selection key 16b is operated, an image icon to be highlighted is selected. That is, when each of the up key, the down key, the left key, and the right key is operated, a highlighted image icon is moved to an image icon next to the highlighted image icon above, below, left, and right, respectively. Then, a list of image icons in Step S23b is displayed on the display unit 15, and one from among the image icons is highlighted.

If a highlighted image icon is on a leftmost side of a line, the projection image selection unit 23 highlights an image on a rightmost side of a line next above to the line by the operation of the left key of the cross selection key 16b. Similarly, if a highlighted image icon is on a rightmost side of a line, an image icon on a leftmost side of a line next below to the line having the highlighted image icon is highlighted by the operation of the right key of the cross selection key 16b.

When the enter key 16a of the input device 16 is operated, the projection image selection unit 23 stores, in the projection image selection unit 23, an image identifier 22b of an image 22a identified by the highlighted image icon (Step S23d). Next, a list of information for identifying the real projection image identifiers 24a is displayed on the display unit 15 in an order of the sequence 24b, and a cursor is displayed after information for identifying a real or virtual projection image identifier 24a with a value stored in the selection unit cursor 24d (Step S23e).

The term “after” means that a cursor is displayed between information for identifying the projection image identifier 24a and information for identifying a projection image identifier 24a immediately after the projection image identifier 24a. When the list is displayed, information for identifying a projection image identifier 24a with a value stored in the projection unit cursor 24e may be highlighted. The highlighting of the projection image identifier 24a will be described below.

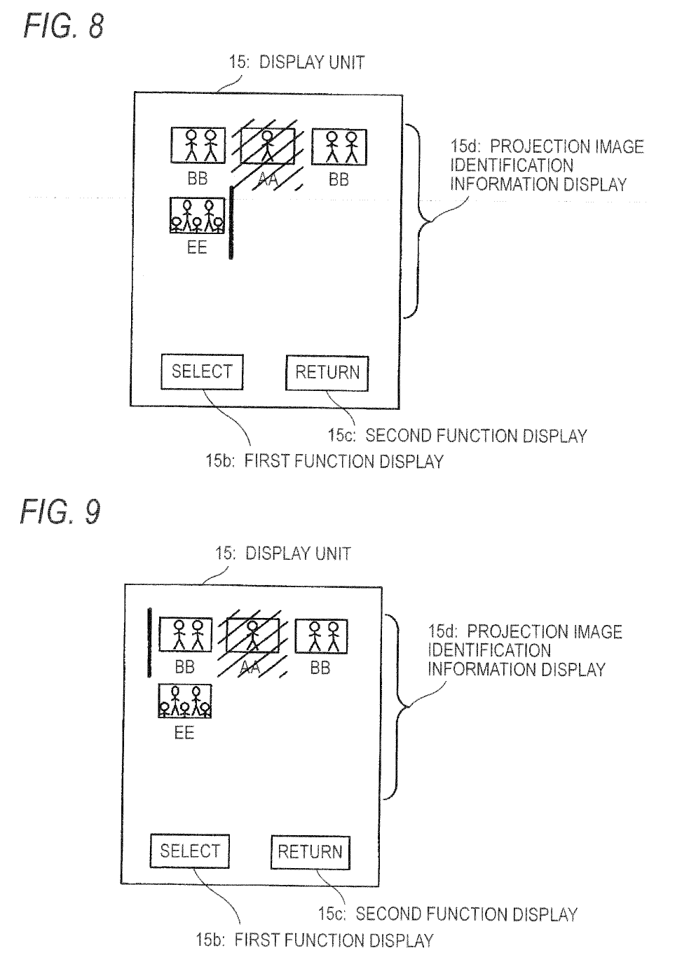

FIG. 8 snows an example where a list of information for identifying the projection image identifiers 24a shown in FIG. 5 is displayed on the display unit 15. In this example, projection image identification information display 15d, in which thumbnail image data 22g of images 22a identified by the image identifiers 24c of the projection image identifier 24a and the image identifiers 22b are arranged in an order of the sequence 24b, that is, in an ascending order of the sequence 24b as information for identifying the real projection image identifier 24a shown in FIG. 5, is displayed in an upper half portion of the display unit 15.

The correspondence between the sequence of display and the display positions of the image icons is the same as when the image icons are displayed, as described with reference to FIG. 7. First function display 15b, “select”, is displayed In a lower left portion of the display unit 15, and second function display 15c, “return”, is displayed in a lower right portion of the display unit 15.

In the projection image identification information display 15d, thumbnail image data 22g of the images 22a and the image identifiers 22b are called image icons. The images 22a are viewed by the image icons of the projection image identification information display 15d, and the sequence 24b is identified by the display positions of the image icons. As a result, the projection image identifier 24a can be identified.

The cursor position is indicated by a vertical bar line In FIG. 5, a value is stored in the selection unit cursor 24d of the projection image identifier 24a with the sequence 24b of “4”. The cursor is displayed after an image icon for identifying the projection image identifier 24a. As shown in FIG. 8, the cursor is displayed after information for identifying a latest sequenced projection image identifier 24a means that the cursor is displayed near the right side of the information for identifying the projection image identifier 24a.

An image icon for identifying a projection image identifier 24a with the sequence 24b of “0” is not displayed. Accordingly, when a value is stored in the selection unit cursor 24d of the projection image identifier 24a with the sequence 24b of “0”, the cursor is displayed at an upper left corner of the display unit 15.

In the following description, it is assumed that when a value is stored in the selection unit cursor 24d of the projection image identifier 24a with the sequence 24b of “0”, the cursor is displayed at the upper left corner of the display unit 15. In addition, it is assumed that the cursor is displayed after an image icon for identifying the projection image identifier 24a with a value stored in the selection unit cursor 24d. That is, it is assumed that the image icon for identifying the projection image identifier 24a with the sequence 24b of “0” is present before the cursor position.

After the operation starts, when the projection image identification information display 15d is initially displayed on the display unit 15, if no value is stored in the selection unit cursor 24d of any projection image identifier 24a, the projection image selection unit 23 stores a value in the selection unit cursor 24d of a projection image identifier 24a, which is latest sequenced, that is, in which the sequence 24b has a maximum value. The projection image identification information display 15d, in which an image icon for identifying the latest sequenced projection image identifier 24a is highlighted, is displayed based on the projection image identifier 24a.

Returning to FIG. 5, a value is stored in the projection unit cursor 24e of a projection image identifier 24a with the sequence 24b of “2”. Hatching indicates that a central image icon in the first line (a second image icon from the left side) is highlighted.

The operation of the projection image selection unit 23 will be further described with reference to FIG. 6. Subsequently, the projection image selection unit 23 examines a key operation of the input device 16 (Step S23f). When the cross selection key 16b is operated, the projection image identifier 24a with a value stored in the selection unit cursor 24d is updated from the projection image identifier 24a with a value stored in the selection unit cursor 24d to a different one, and the updated projection image identifier 24a is updated and stored in the projection image identifier storage unit 24 (Step S23g).

That is, when each of the up key, the down key, the left key, and the right key is operated, the projection image selection unit 23 sets a value in the selection unit cursor 24d of each of projection image identifiers 24a with the sequence 24b of a smaller value by three, the sequence 24b of a larger value by three, the sequence 24b of a smaller value by one, and the sequence 24b of a larger value by one, respectively, and updates and stores the projection image identifier 24a in the projection image identifier storage unit 24. In FIG. 8, the numerical value “three” is used because three image icons are displayed in each line.

Next, the projection image selection unit 23 is switched to execute an operation to display a list of image icons for identifying the real projection image identifiers 24a in Step S23e, and to display a cursor after an image icon for identifying the projection image identifier 24a with the value stored in the selection unit cursor 24d. At this time, the position where the cursor is to be displayed is changed in accordance with the above-described operation.

When the enter key 16a of the input device 16 is operated, the projection image selection unit 23 adds a projection image identifier 24a having the image identifier 22b stored in Step S23d as the image identifier 24c immediately after the real or virtual projection image identifier 24a identified by the image icon before cursor display, and update and stores the projection image identifier 24a in the projection image identifier storage unit 24 (Step S23h).

The sequence 24b of the projection image identifier 24a caused by the addition is set to the natural number described above. A value is stored in the selection unit cursor 24d of the added projection image identifier 24a. Meanwhile, no value is stored in the projection unit cursor 24e of the added projection image identifier 24a.

Next, the projection image selection unit 23 is switched to display a list of information for identifying the images 22a in Step S23b on the display unit 15, and to highlight information for identifying one from among the images 22a.

The projection image selection unit 23 ends the first operation in any step on the basis of a predetermined key operation of the input device 16. The same operation is executed by the operation of the first function key 16c near the first function display 15b, instead of the enter key 16a. This is because the first function display 15b is “select”, and the “select” operation, that is, selection is decided by the operation of the first function key 16c.

When the operation ends, the projection image selection unit 23 may erase the value of the selection unit cursor 24d. With the erasure operation, when being actuated next time, the projection image selection unit 23 displays, on the display unit 15, projection image identification information display 15d, in which information for identifying a projection image identifier 24a, which is latest sequenced, that is, in which the sequence 24b has a maximum value.

This is suitable for a case where the projection image identifier 24a is also latest sequenced and additionally stored next time, in other words, an image 22a to be projected on the image output unit 21 is added to the end of the image 22a, which has been already projected and stored. The projection image identifier 24a with the sequence 24b of a maximum value may be real or virtual.

Meanwhile, with a non-erasure operation, when being activated next time, the projection image selection unit 23 displays, on the display unit 15, projection image identification information display 15d, in which information for identifying a projection image identifier 24a, which is operated lately, is highlighted. This is suitable for a case where the projection image identifier 24a, which is operated lately, and a projection image identifier 24a, which is sequenced next to the projection image identifier 24a, or a projection image identifier 24a, which is near the projection image identifiers 24a is additionally stored.

With the operation of the second function key 16d near the second function display 15c, the projection image selection unit 23 returns to a state where a predetermined key operation of the input device 16, which was executed last, is not made. Referring to the flowchart of FIG. 6, the projection image selection unit 23 returns to a state where an operation in a last step is not made. This is because the second function display 15c is “return”, and by the operation of the second function key 16d, the projection image selection unit 23 returns to a state before a last operation is executed.

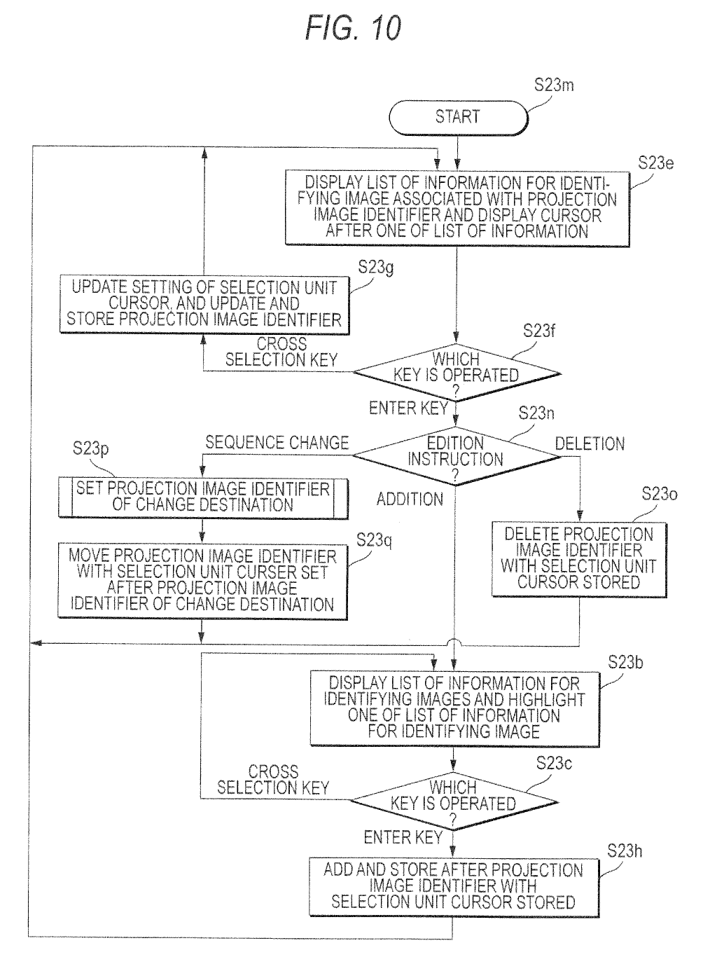

FIG. 10 is a flowchart of the second operation that the projection image selection unit 23 selects an image 22a, and stores a real projection image identifier 24a, in which the image identifier 22b of the selected image 22a is set as the image identifier 24c. The second operation is, for example, suitable for a case where the projection image identifier 24a is stored beforehand, that is, when the projection image identifier 24a is updated and stored. The second operation includes the same steps as those in the first operation. The same steps are represented by the same reference numerals, and descriptions thereof will be omitted.

The projection image selection unit 23 is activated by the control unit 11 on the basis of a predetermined key operation of the input device 16, and starts the second operation (Step S23m). After in Steps S23e to S23g, projection image identification information display 15d is displayed and the projection image identifier 24a with the value stored in the selection unit cursor 24d is decided, an instruction to edit the projection image identifier 24a is input on the basis of a predetermined key operation of the input device 16, and the Instruction is examined (Step S23n).

When the instruction is addition, after in Steps S23b and S23c, image identification information display 15a is displayed and an image 22a is decided, in Step S23h, the projection image selection unit 23 adds and stores a projection image identifier 24a with the image identifier 22b of the decided image 22a as the image identifier 24c immediately after the decided projection image identifier 24a. Next, in Step S23e, the projection image identification information display 15d is displayed.

When the instruction input in Step S23n is addition, the second operation is the same as the first operation, except that which of the image 22a to be added and the sequence of the projection image identifier 24a to be added is first decided executed.

In Step S23n, when the input instruction is deletion, the projection image selection unit 23 deletes the real projection image identifier 24a with the value stored in the selection unit cursor 24d, and updates the projection image identifier storage unit 24 (Step S23o). Next, in Step S23e, the projection image identification information display 15d is displayed.

The projection image selection unit 23 stores a value in the selection unit cursor 24d of a projection image identifier 24a immediately after the projection image identifier 24a to be deleted When the projection image identifier 24a to be deleted is latest sequenced, a value is stored in the selection unit cursor 24d of a projection image identifier 24a, which is latest sequenced after deletion.

When a value is stored in the projection unit cursor 24e of the projection image identifier 24a to be deleted, the projection image selection unit 23 stores a value in the projection unit cursor 24e of a projection image identifier 24a, which is sequenced immediately after the projection image identifier 24a to be deleted. When the projection image identifier 24a to be deleted is latest sequenced, a value is stored in the projection unit cursor 24e of a projection image identifier 24a, which is latest sequenced after deletion. A control of an image to be projected by storing a value in the projection unit cursor 24e of the projection image identifier 24a will be described when the operation of the image projection control unit 25 is described.

In Step S23n, when the input instruction is sequence change, the projection image selection unit 23 sets a real or virtual projection image identifier 24a of a channel destination (Step S23p). The operation to set the projection image identifier 24a is the same as the operation in Steps S23e to S23g to display the projection image identification information display 15d and to decide the projection image identifier 24a with the value stored in the selection unit cursor 24d. Therefore, a description thereof will be omitted.

Next, the projection image selection unit 23 changes the sequence of the projection image identifier 24a with the value stored in the selection unit cursor 24d. That is, the projection image identifier 24a is sequenced immediately after the projection image identifier 24a of the change destination set in Step S23p (Step S23q). Next, in Step S23e, the projection image identification information display 15d is displayed. The sequence change is accompanied by a change in value of the sequence 24b, but not a change of the projection image identifier 24a with the value stored in the selection unit cursor 24d. In addition, the sequence change is not accompanied by a change of the projection image identifier 24a with the value stored in the projection unit cursor 24e.

When the projection image identifier 24a is changed, and updated and stored in the projection image identifier storage unit 24, and the image projection control unit 25 is in operation, the projection image selection unit 23 notifies the image projection control unit 25 that the projection image identifier 24a is changed. This notification may be executed by an interrupt or may be written into a shared memory. When only the projection image identifier 24a with the value stored in the selection unit cursor 24d is changed, the notification may be not executed.

The projection image selection unit 23 ends the second operation in any step on the basis of a predetermined key operation of the input device 16. The same operation is executed by the operation of the first function key 16c, which is near the first function display 15b, instead of the enter key 16a.

When the operation ends, the projection image selection unit 23 may erase the value of the selection unit cursor 24d or not. The reason is as described in the first operation of the projection image selection unit 23.

The projection image selection unit 23 returns a state, in which a last key operation of the input device 16 is not executed, by the operation of the second function key 16d near the second function display 15c Referring to the flowchart of FIG. 10, the projection image selection unit 23 returns a state where an operation in a last step is not executed.

In Step S23n of the second operation of the projection image selection unit 23, a copy instruction may be further input. A copy operation is similar to the operation for sequence change. That is, in the sequence change, the projection image identifier 24a with the value stored in the selection unit cursor 24d is sequenced immediately after the projection image identifier 24a of the change destination set in Step S23p. Meanwhile, in the copy operation, the projection image identifier 24a with the value stored in the selection unit cursor 24d is copied immediately after the projection image identifier 24a of the change destination set in Step S23p.

The projection image identifier 24a with the value stored in the selection unit cursor 24d is the projection image identifier 24a, which is sequenced or copied immediately after the projection image identifier 24a of the change destination set in Step S23p, but this is not intended to limit the invention. Before the copy operation, a projection image identifier 24a with a value stored in the selection unit cursor 24d may be used.

Regardless of the first operation or the second operation, when the projection image identifier 24a with the value stored in the selection unit cursor 24d in Step S23f is updated from the projection image identifier 24a with a value currently stored in the selection unit cursor 24d to another one, on the basis of a predetermined key operation of the input device 16, the projection image selection unit 23 stores a value in the selection unit cursor 24d of the real projection image identifier 24a with the value stored in the projection unit cursor 24e.

This operation is an operation that the projection image selection unit 23 edits, that is, adds or deletes the projection image identifier 24a while being sequenced near the image identifier 24c for identifying the image 22a projected or previously projected by the image projection control unit 25.

That is, when the user makes a presentation using images to be projected, when the images are not projected and the presentation is suspended, or before a next presentation is given after a presentation ends, edition is executed. For example, a new image is sequenced near an image being projected or an image previously projected, or an image, which is sequenced near an image being projected, is deleted. Therefore, an image, which is not to be projected before a presentation, is projected, or an image, which is to be projected, is not projected.

As such, the first operation and the second operation of the projection image selection unit 23 are not contrary to each other. After the first operation starts, the projection image selection unit 23 is switched to the second operation on the basis of a predetermined key operation of the input device 16. That is, the projection image identifier 24a may be successively added, and then edition may be executed. Alternatively, after the second operation starts, the projection image selection unit 23 may be switched to the first operation. That is, the projection image identifier 24a may be first edited, and then addition may be continued. Switching of the operations causes a change in input presence/absence of an edition instruction in Step S23n.

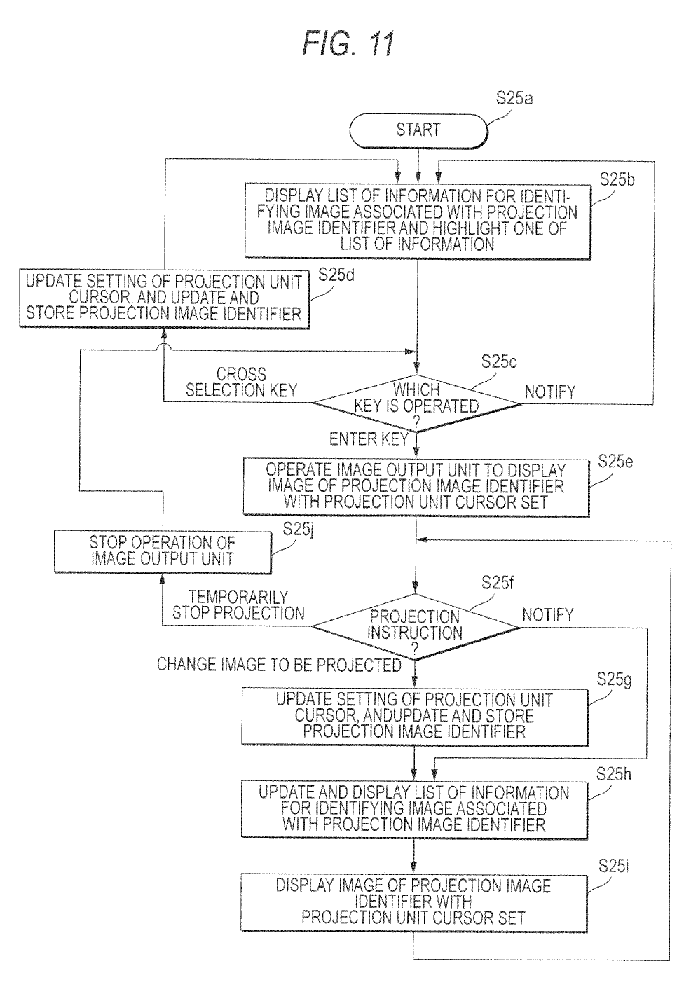

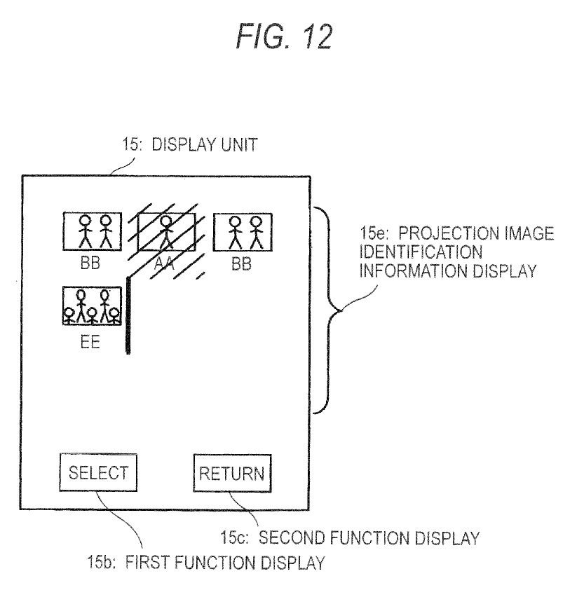

Next, an operation that the image projection control unit 25 projects the image 22a identified by the image identifier 24c of the real projection image identifier 24a on the image output unit 21 will be described. FIG. 11 is a flowchart of an operation that the image projection control unit 25 projects the image 22a identified by the image identifier 24c of the real projection image identifier 24a on the image display unit 21.

The image projection control unit 25 is actuated by the control unit 11 on the basis of a predetermined key operation of the input device 16, and starts the above-described operation (Step S25a). Next, a list of information for identifying the real projection image identifiers 24a is displayed on the display unit 15 in an order of the sequence 24b, and information for identifying the projection image identifier 24a with the value stored in the projection unit cursor 24e is highlighted (Step S25b). When the list is displayed, as described with reference to FIG. 8, the cursor may be displayed after the information for identifying the projection image identifier 24a with the value stored in the selection unit cursor 24d.

When there is no projection image identifier 24a with the value stored in the projection unit cursor 24e, the image projection control unit 25 stores a value in the projection unit cursor 24e of the projection image identifier 24a with the sequence 24b of “1”, and updates and stores the projection image identifier 24a. Therefore, information for identifying the projection image identifier 24a with the sequence 24b of “1” is highlighted.

FIG. 12 shows an example where a list of information for identifying the projection image identifiers 24a shown in FIG. 5 is displayed on the display unit 15. In this example, projection image identification information display 15e, in which thumbnail image data 22g of the images 22a identified by the image identifiers 24c of the projection image identifier 24a and the image identifiers 22b are arranged in an order of the sequence 24b as the information for identifying the real projection image identifier 24a shown in FIG. 5, is displayed in the upper half portion of the display unit 15.

The correspondence between the sequence and the display positions of the image icons is the same as when the image icons are displayed, as described with reference to FIG. 7. In the projection image identification information display 15e, thumbnail image data 22g of the images 22 and the image identifiers 22b are called as image icons. First function display 15b, “select” is displayed in a lower left portion of the display unit 15, and second function display 15c, “return”, is displayed in a lower right portion of the display unit 15.

In FIG. 5, a value is stored in the projection unit cursor 24e of the projection image identifier 24a in which the sequence 24b is “2”, and the image identifier 24c is “AA”. Hating indicates that a central image icon in the first line (a second image icon from the left side) with the image identifier 22b of “AA” is highlighted The highlighting is not limited to hatching. For example, the frame of thumbnail image data 22g included in the image icon may be colored with a color different from the frame of other thumbnail image data 22g.

In FIG. 5, a value is stored in the selection unit cursor 24d of the projection image identifier 24a with the sequence 24b of “4”. Accordingly, the cursor is displayed after an image icon for identifying the projection image identifier 24a.

Display including the projection image identification information display 15e, which is described with reference to FIG. 12, is the same as display including the projection image identification information display 15d, which is described with reference to FIG. 8. However, in the projection image identification information 15d, the image icon for identifying the image identifier 24c with a value stored in the projection unit cursor 24e may not be highlighted. Meanwhile, in the projection image identification information display 15e, the cursor position based on the selection unit cursor 24d may be indicated by a vertical bar line.

The operation of the image projection control unit 25 will be further described with reference to FIG. 11. Subsequently, the image projection control unit 25 examines a key operation of the input device 16. At this time, it is also examined whether or not a notification is sent from the projection image selection unit 23 (Step S25c). When the cross selection key 16b is operated, a projection image identifier 24a with a value stored in the projection unit cursor 24e is updated from the projection image identifier 24a with the value currently stored in the projection unit cursor 24e. Next, the updated projection image identifier 24a may be updated and stored in the projection image identifier storage unit 24 (Step S25d).

That is, when each of the up key, the down key, the left key, and the right key is operated, the image projection control unit 25 stores a value in the projection unit cursor 24e of each of the projection image identifiers 24a with the sequence 24b of a smaller value by three, the sequence 24b of a larger value by three, the sequence 24b of a smaller value by one, and the sequence 24b of a larger value by one, respectively. In FIG. 12, the numerical value “three” is used because three image icons are displayed in each line.

Next, the image projection control unit 25 is switched to control the display unit 15 to display a list of image icons for identifying the projection image identifiers 24a in Step S25b, and to highlight an image icon for identifying a projection image identifier 24a with a value stored in the projection unit cursor 24e. At this time, a highlighted image icon is changed in accordance with the above-described operation.

In Step S25c, when there is a notification that a change is given from the projection image selection unit 23 to the projection image identifier 24a, the image projection control unit 25 is switched to control the display unit 15 to display a list of image icons for identifying the projection image identifiers 24a in Step S25b, aid to highlight the image icon for identifying a projection image identifier 24a with the value stored in the projection unit cursor 24e. This is because the notification from the projection image selection unit 23 means that a change occurs in any projection image identifier 24a, and thus the change should be reflected in display of the display unit 15.

In Step S25c, when the enter key 16a of the input device 16 is operated, the image projection control unit 25 supplies power to the image output unit 21 to operate the image output unit 21. Next, the image projection control unit 25 selects image data 22f of an image 22a identified by the image identifier 24c of the projection image identifier 24a, which is identified by the highlighted image icon, as image data 22f to be projected, and transmits image data 22f to the image output unit 21. Thus, image data is projected on the image output unit 21 (Step S25e).

When the image projection control unit 25 starts to operate, and Step S25c after Step S25b is executed first time, in Step S25c, the image projection control unit 25 may regard as that a key operation of the input device 16 is executed, and the enter key 16a is operated. Therefore, image data 22f can be projected immediately after the operation starts.

Next, the image projection control unit 25 examines a projection instruction input by a key operation of the input device 16, and determines whether the projection Instruction is to change image data 22f to be projected or to temporarily stop the projection. Here, it is also examined whether or not there is a notification from the projection image selection unit 23 (Step S25f). First, in all cases, a case where it is determined that the input projection instruction is an instruction to change image data 22f to be projected will be described.

The change of image data 22f to be projected is the same as a change of an image icon to be highlighted For this reason, an operation to change image data 22f to be projected may be regarded as an operation to change an image icon to be highlighted. The change of image data 22f to be projected is performed by the following operations. First, as described in Step S25c, the operation of the cross selection key 16b is executed. When an image 22a is projected for a predetermined time, it may be regarded as that the right key of the cross selection key 16b may be operated.

Second, a predetermined key operation of the input unit 16 for a change to an initially positioned real projection image identifier 24a (a projection image identifier 24a with the sequence 24b of “1”) is executed. When a highlighted image icon is a latest sequenced image icon, and an image 22a corresponding to the image icon is projected, if the right key of the cross selection key 16b is operated or if the image 22a is projected for a predetermined time, it may be regarded as that a predetermined key operation of the input unit 16 for a change to the initially sequenced real projection image identifier 24a is executed.

Third, a predetermined key operation of the input device 16 for a change to a latest sequenced projection image identifier 24a is executed. Fourth, a predetermined key operation of the input device 16 for a change to a projection image identifier 24a, which is sequenced before the highlighted image icon by n image icons (where n is a natural number of 1 or more, 1≦n), is executed. Fifth, a predetermined key operation of the input device 16 for a change to a projection image identifier 24a, which is sequenced after the highlighted image icon by n image icons (where n is a natural number of 1 or more, 1≦n), is executed. Sixth, a predetermined key operation of the input device 16 for a change to a projection image identifier 24a, which is sequenced n-th from the first image icon (where n is a natural number of 1 or more, 1≦n), is executed.

Seventh, a predetermined key operation of the input device 16 for a change to a projection image identifier 24a with a value stored in the selection unit cursor 24d is executed. With this operation, an image icon before a vertical bar line, which indicates a projection image identifier 24a with a value stored in the selection unit cursor 24d, is highlighted.

When the sequence 24b of the projection image identifier 24a with a value stored in the selection unit cursor 24d is “0”, by the above-described operation, image data 22f to be projected is changed to image data 22f of an image 22a identified by the image identifier 24c of the projection image identifier 24a with the sequence 24b of “1”.

In Step S25f, when a key of the input device 16 is operated to instruct a change of image data 22f to be projected, the image projection control unit 25 stores a value in a projection unit cursor 24e associated with an image identifier 24c corresponding to a newly highlighted image icon, and updates and stores the projection image identifier 24a (Step S25g).

Next, as described above, the image projection control unit 25 controls the display unit 15 to display the projection image identification information display 15e, in which a highlighted image icon is changed (Step S25h). Next, the image projection control unit 25 transmits image data 22f of an image 22a identified by an image identifier 24c of a projection image identifier 24a, which is identified by the highlighted image icon, to the image output unit 21, such that the image 22a is projected on the image output unit 21. (Step S25i). Next, the image projection control unit 25 examines a projection instruction input by a key operation of the input device 16 in Step S25f.

In Step S25f, if a key of the input device 16 is operated to instruct a temporarily stop of projection, the image projection control unit 25 is switched to shut off power supply to the image output unit 21 to stop the image output unit 21 (Step S25j), and to examine a key operation of the input device 16 in Step S25c. With the return to Step S25c, the image projection control unit 25 can select image data 22f of an image 22a to be next projected without suppressing power consumption by the image output unit 21.

In Step S25f, where there is a notification that a change is given from the projection image selection unit 23 to the projection image identifier 24a, the image projection control unit 25 is switched to control the display unit 15 to display the projection image identification information display 15e in Step S25h. This is because the notification from the projection image selection unit 23 means that a change occurs in any projection image identifier 24a, and the change should be reflected. The change causes a change in the projection image identification information display 15e, and also causes a change in the image 22a to be projected on the image output unit 21.

The image projection control unit 25 ends the operation to project the image 22a on the image output unit 21 in any step on the basis of a predetermined key operation of the input device 16. The same operation is executed by the operation of the first function key 16c, which is near the first function display 15b, instead of the enter key 16a. Before the operation ends, power supply to the image output unit 21 is shut off.

When the operation ends, the image projection control unit 25 may erase the value of the projection unit cursor 24e. With the erasure operation, when being actuated next time, the image projection control unit 25 controls the display unit 15 to display the projection image identification information 15e, in which information for identifying the projection image identifier 24a with the sequence 24b of “1” is highlighted For this reason, this is suitable for a case where an image 22a identified by an image identifier 24c is sequenced based on the sequence 24b in association with the image identifier 24c next time, and projected on the image output unit 21.

Meanwhile, with a non-erasure operation, when being actuated next time, the image projection control unit 25 controls the display unit 15 to display the projection image identification information display 15e, in which information for identifying a projection image identifier 24a corresponding to an image 22a projected lately is highlighted. Therefore, this is suitable for a case where an image 22a identified by an image identifier 24c, which is sequenced to or near the image 22a projected lately, is projected on the image output unit 21 next time. For example, this is applied to a case where a presentation subsequent to this presentation is given.

By the operation of the second function key 16d near the second function display 15c, the image projection control unit 25 returns to a state where a predetermined key operation of the input device 16, which was performed last, is not executed. Referring to the flowchart of FIG. 11, the image projection control unit 25 returns a state where an operation in a last step is not executed.

When the cursor position based on the selection unit cursor 24d is indicated by the vertical bar line in the projection image identification information display 15e, and when the projection instruction is input in Step S25f, as described in the seventh operation to specify image data 22f to be projected, the image projection control unit 25 projects image data 22f of the image 22a identified by the real projection image identifier 24a with the value stored in the selection unit cursor 24d.

This operation is an operation that the image projection control unit 25 projects image data 22f of an image 22a identified by a projection image identifier 24a, which is added by the projection image selection unit 23 and subjected to the sequence change. Therefore, when the user makes a presentation using the images to be projected, an image, which is not to be projected before the presentation, is immediately projected.

An example of this operation will be described. When no real projection image identifier 24a is not stored in the projection image identifier storage unit 24, the image projection control unit 25 cannot control projection of the image 22a on the basis of a key operation of the input device 16 in Step S25c after the operation starts because a projection image identifier 24a with a value stored in the projection unit cursor 24e is not stored. Accordingly, the image projection control unit 25 waits for a notification from the projection image selection unit 23.

When the projection image selection unit 23 stores the real projection image identifier 24a in the projection image identifier storage unit 24, and the notification is sent, the image projection control unit 25 can project image data 22f of an image 22a identified by a projection image identifier 24a, which is immediately and newly input. When the real projection image identifier 24a is not stored in the projection image identifier storage unit 24, to notify the start of the operation, the image projection control unit 25 controls an image to be projected on the image output unit 21 with lower luminance that when image data 22f is projected. An image to be projected is arbitrary.

As described above, the projection image selection unit 23 and the image projection control unit 25 may be operated at the same time. That is, the user (for example, a presenter) operates the image projection control unit 25 to control an image 22a according to his/her intention to be projected on the image output unit 21, and also operates the projection image selection unit 23 to select an image 22a to be projected and to perform sequencing. The selection and sequencing is not projected by the image output unit 21, and wasteful projection is not viewed by a portion other than the user.

If the two processing units (the projection image selection unit 23 and the image projection control unit 25) are operated at the same time, it is necessary to control how the resources used by the processing units are allocated to the processing units. In regards to four resources including the CPU resource, the main storage device resource, the display resource regarding the display unit 15, and the key operation resource of the input device 16, allocation control is needed. Allocation control of two resources by the control unit 11 will now be described.

First, allocation of the CPU resource by the control unit 11 will be described. The control unit 11 detects an interrupt from the input device 16 due to a key operation or a key operation of the input device 16 by polling, and allocates the CPU resource to a processing unit to which the key operation resource is allocated. Allocation control is, for example, CPU resource allocation in a general-use multitask system, and is easily performed.

Allocation of the main storage device by the control unit 11 will now be described. On an assumption that the apparatus has a main storage device resource which exceeds storage capacity to be allocated to the two processing units, the control unit 11 allocates the main storage device resource to the two processing units. When no storage capacity to be allocated to the two processing units, the control unit 11 performs allocation control, for example, by a known sequence.

Next, allocation of the display resource regarding the display unit 15 by the control unit 11 will be described. The control unit 11 allocates the display resource regarding the display unit 15 to the projection image selection unit 23 and/or the image projection control unit 25 by using one or more from among the following methods. First, the control unit 11 has a multi-window system, and allocates two windows to the projection image selection unit 23 and the image projection control unit 25, respectively.

Second, when no multi-window system is provided in the control unit 11, the control unit 11 allocates the display resource regarding the display unit 15 to one of the projection image selection unit 23 and the image projection control unit 25 on the basis of a predetermined key operation of the input device 16. With this method, it is necessary for the user to execute a predetermined key operation to switch display on the display unit 15 by the projection image selection unit 23 and display on the display unit 15 by the image projection control unit 25. In any of two types of display, however, the user can view display according to his/her intention.

Third, when no multi-window system is provided in the control unit 11, if a key operation is detected by interrupt or polling, the control unit 11 allocates the display resource regarding the display unit 15 to a processing unit, to which the key operation resource is allocated. With this method, when the user inputs an instruction to the projection image selection unit 23, he/she can view display by the projection image selection unit 23. When the user inputs an instruction to the image projection control unit 25, he/she can view display by the image projection control unit 25.

Fourth, when no multi-window system is provided in the control unit 11, the control unit 11 allocates the display resource regarding the display unit 15 to the projection image selection unit 23. With this method, allocation control of the display resource regarding the display unit 15 by the control unit 11 is easily performed. With this method, the user cannot view the projection image identification information display 15e by the image projection control unit 25, but he/she can view the projection image identification information display 15d by the projection image selection unit 23.

When the user views the projection image identification information display 15d, an image icon corresponding to an image 22a being currently projected is preferably highlighted. Even if the image icon is not highlighted, however, the projection image selection unit 23 and the image projection control unit 25 are operated at the same time. Accordingly, with understanding of the sequence of an image 22a being currently projected, the user may consider that a change of an image 22a to be projected is executed. For this reason, an image icon corresponding to the image 22a being currently projected is not identified, and the user feels inconvenience. As a result, when the image projection control unit 25 is operated, and the projection image selection unit 23 is not operated, the display resource regarding the display unit 15 is allocated to the image projection control unit 25.

Next, allocation of the key operation resource of the input device 16 by the control unit 11 will be described. The input device 16 of the mobile communication terminal has a limited number of keys. Accordingly, in order to cause each of the projection image selection unit 23 and the image projection control unit 25 to execute a desired operation, it is necessary for the user to easily determine to which of the two processing units a key operation is given. To this end, by using one or more from among the following methods, the control unit 11 notifies one of the projection image selection unit 23 in operation and the image projection control unit 25 in operation that a key operation is executed.

First, the control unit 11 sets one of the projection image selection unit 23 and the image projection control unit 25 as a processing unit, to which execution of a key operation is notified, on the basis of a predetermined key operation of the input device 16. With this method, when the user inputs an instruction to one processing unit, and then inputs an instruction to the other processing unit, it is necessary for the user to execute a predetermined key operation to change a processing unit, to which an instruction is input. However, all key operations of the input device 16 (excluding a predetermined key operation to change a processing unit, to which an instruction is input) can be notified to any processing unit, and an instruction can be input to both the processing units by a key operation according to the user's intention.

Second, the control unit 11 notifies the projection image selection unit 23 that a key provided on the inner surface of the lower housing MS2 is operated. Meanwhile, the control unit 11 notifies the image projection control unit 25 that a side key 16e provided on the side surface of the lower housing MS2 is operated.

The instruction to the projection image selection unit 23 include two instructions, that is, an instruction to select an image 22a to be projected and an instruction to sequence of projection of the selected image 22a. An instruction to the image projection control unit 25 includes an instruction to change an image 22a to be projected with reference to the sequence. In many cases, a simple instruction to change an image 22a to be projected in an order of the sequence may be used.

There is little possibility that the user operates the projection image selection unit 23 to select and sequence an image 22a desired for projection, while he/she operates the image projection control unit 25 to project the image 22a. in many case, the user select and sequence the images 22a beforehand.

The instruction to the image projection control unit 25 does not necessary require a large number of keys, but it is preferably input by a key, which is easily operable without seeing, a key, which causes little vibration of the upper and lower housings MS1 and MS2 during a key operation, and a key, which is operable in a state where the upper and lower housings MS1 and MS2 are closed. For example, the side key 16e may be used.

In a state where the upper and lower housings MS1 and MS2 are closed, if the image projection control unit 25 is operated, power consumption by the display unit 15 can be reduced. In addition, when a key is provided on the outer surface of the upper or lower housing MS1 or MS2, as well as the side surface, as described above, the key on the outer surface may be appropriately used for the instruction to the image projection control unit 25.

When three side keys 16e are provided, an operation of an upper side key 16e is used to instruct the image projection control unit 25 to project an image 22a, which is initially sequenced. An intermediate side key 16e is used to instruct the image projection control unit 25 to project an image 22a, which is sequenced immediately before the image 22a being projected. A lower side key 16e is used to instruct the image projection control unit 25 to project an image 22a, which is sequenced immediately after an image 22a being projected. This is because an image 22a, which is sequenced previously and projected earlier, is arranged above and an image 22a, which is sequenced later and projected later, is arranged below, and accordingly, the arrangement conforms to the user's actual feeling.

When two side keys 16e are provided, an upper side key 16e is used to instruct the image projection control unit 25 to project an image 22a, which is sequenced immediately before an image 22a being projected. A lower side key 16e is used to instruct the image projection control unit 25 to project an image 22a, which is sequenced immediately after the image 22a being projected. When a single side key 16e is provided, the side key 16e is used to instruct the image projection control unit 25 to project an image 22a, which is sequenced immediately after an image 22a being projected. This is because a projection instruction is most input to the image projection control unit 25.

Third, the operations of the up key and the down key of the cross selection key 16b are notified to the image projection control unit 25. Meanwhile, the operations of other keys (including the left key and the right key of the cross selection key 16b) are notified to the projection image selection unit 23.

The up key of the cross selection key 16b is used to instruct the image projection control unit 25 to project an image 22a, which is sequenced immediately before an image 22a being projected. The down key of the cross selection key 16b is used to instruct the image projection control unit 25 to project an image 22a, which is sequenced immediately after the image 22a being projected This is because an image 22a, which is sequenced previously and projected earlier, is arranged above and an image 22a, which is sequenced later and projected later, is arranged below, and accordingly, the arrangement conforms to the user's actual feeling.

Meanwhile, the projection image selection unit 23 can execute all the operations by the operations of the left key and the right key of the cross selection key 16b, instead of the up key and the down key of the cross selection key 16b. This is because the operations of the left key and the right key are similar to a case where the characters of the sentence are written horizontally, and accordingly the arrangement conforms to the user's actual feeling.

In the foregoing description, the projection image selection unit 23 and the image projection control unit 25 are provided as separate processing units, but the invention is not limited thereto. For example, the projection image selection unit 23 may include the function of the image projection control unit 25 and project an image 22a identified by an image identifier 24c of a projection image identifier 24a on the image output unit 21.

In this case, when the projection image identification information display 15d shown in FIG. 8 is displayed on the display unit 15, the projection image selection unit 23 selects a highlighted image icon on the basis of a predetermined key operation of the input device 16. Next, a value is stored in the projection unit cursor 24e of a projection image identifier 24a corresponding to the image icon, and an image 22a identified by the image identifier 24c of the projection image identifier 24a is projected on the image output unit 21.

In the foregoing embodiment, the image output unit 21 is a projector that projects an image outside of the apparatus, but the invention is not limited thereto. A processing unit, may he used, which transmits image signals and control signals for instructing power supply and shutoff, and luminance change to a display, which displays image outside the apparatus, for example, a television receiver.

In the foregoing description, the input device 16 is provided in the lower housing MS2, but the invention is not limited thereto. The input device 16 may be provided in the upper housing MS1. In addition, a remote control device (not shown), which is connected to the apparatus in a wired system or a wireless system, may be provided. The wireless system may be an infrared system or a Bluetooth (Registered Trademark) system.

The remote control device may be provided with other devices, in addition to the input device 16. For example, the remote control device may be an earphone (not shown) that is connected to the apparatus through a Bluetooth (Registered Trademark) In addition, when the input device 16 is provided in the remote control device, the upper and lower housings MS1 and MS2 are not vibrated by a key operation of the input device 16. Therefore, an image to be projected is not vibrated. The invention is not limited to the above-described embodiment, but various changes and modifications may be made without departing from the scope of the invention.

As described with reference to the embodiment, there is provided an information processing apparatus that displays a list of information for identifying images, and on the basis of two operations including an operation to select one of the displayed information and an operation to decide the selection, externally displays an image identified by the selected information.

According to the embodiment, a list of information for identifying images can be displayed, and on the basis of two operations including an operation to select one of the displayed information and an operation to decide the selection, an image identified by the selected information can be externally displayed.

What is claimed is:

1. An information processing apparatus comprising:
an input unit;
a display unit;
an image output unit;
an image storage unit that stores images;
an image selection unit that controls the display unit to display a list of information for identifying the images stored in the image storage unit, selects one item from the list by a first operation input to the input unit, and decides the selected item as a decided item by a second operation input to the input unit; and
an image display control unit that controls the image output unit to output an image identified by the decided item to exterior of the information processing apparatus.

2. An information processing apparatus comprising:
an input unit;
a display unit;
an image output unit;
an image storage unit that stores images;
an image identification information storage unit that stores information for identifying the images stored in the image storage unit;
an image selection unit that controls the display unit to display a list of the information for identifying the images, selects one item from the list by a first key operation input to the input unit, decides the selected item as a decided item by a second operation input to the input unit, and controls the image identification information storage unit to store information with respect to the selected item and display sequence of the selected item; and
an image display control unit that selects one of the information stored in the image identification information storage unit based on the display sequence in the wake of a third operation input to the input unit, and controls the image output unit to display an image identified by the selected information.

3. The information processing apparatus according to claim 2,
wherein the image identification information storage unit further identifiably stores information for identifying an image latest stored or updated by the image selection unit, and
the image display control unit controls the image output unit to display an image identified by the information latest stored or updated by the image selection unit from among the information stored in the image identification information storage unit.

4. The information processing apparatus according to claim 2,
wherein the image identification information storage unit further identifiably stores output information for identifying the image output from the image display control unit, and
wherein the image selection unit controls the image identification information storage unit to store the selected output information so that display sequence of the selected information is immediately before or after the selected output information.

5. The information processing apparatus according to claim 2 further comprising a casing having a front face, side faces, and a rear face,
wherein the first operation and the second operation are input to a first key provided on the front face, and
wherein the third operation is input to a second key provided on the side faces or the rear face.

6. The information processing apparatus according to claim 2 further comprising a plurality of housings coupled to each other to have a close state and a open state,
wherein the first operation and the second operation are input to keys provided on at least one of inner faces opposing and closing to each other in the close state, and
wherein the third operation is input to a key provided on at least one of faces of the housings except the inner faces in the close state.

7. The information processing apparatus according to claim 2,
wherein the first keys include a left key, a right key, up key, and a down key, and
wherein the first operation is an operation of the left key or the right key, and the third operation is an operation of the up key or the down key.

8. The information processing apparatus according to claim 2,
wherein the information for identifying the images includes thumbnail images created from the images.

9. The information processing apparatus according to claim 2 further comprising:
an external signal input unit; and
a remote control device to which the first operation and the second operation are input instead of the input unit, being connected to the external signal input unit by a wired or wireless connections.

10. The information processing apparatus according to claim 2 further comprising:
an external signal input unit; and
a remote control device to which the third operation is input instead of the input unit, being connected to the external signal input unit by a wired or wireless connections.

11. The information processing apparatus according to claim 1,
wherein the image output unit includes a projector.

12. The information processing apparatus according to claim 2,
wherein the image output unit includes a projector.
